(19) United States
(12) Patent Application Publication
(10) Pub. No.: US 2014/0223743 A1
(43) Pub. Date: Aug. 14, 2014

(54) METHOD FOR PRODUCING A MOTOR VEHICLE STABILIZER

(71) Applicant: Benteler Automobiltechnik GmbH, Paderborn (DE)

(72) Inventors: Andreas Frehn, Delbruck (DE); ULLRICH HAMMELMAIER, Paderborn (DE)

(73) Assignee: Benteler Automobiltechnik GmbH, Paderborn (DE)

(21) Appl. No.: 14/160,218

(22) Filed: Jan. 21, 2014

(30) Foreign Application Priority Data
Feb. 8, 2013 (DE) 10 2013 101 276.0

(51) Int. Cl. B60G 21/055

(52) U.S. Cl. CPC B60G 21/055
USPC 29/897.2

(57) ABSTRACT

A method for producing a motor vehicle stabilizer, configured as a hollow tubular component, includes the steps of method steps of providing a steel strip made of a high-manganese-content steel alloy having TWIP and/or TRIP properties, forming a tubular profile from the steel strip, longitudinal seam welding of the tubular profile to form a tube, and bending the tube into the stabilizer rod.

### CROSS-REFERENCES TO RELATED APPLICATIONS

This application claims the priority of German Patent Application, Serial No. 10 2013 101 276.0, filed Feb. 8, 2013, pursuant to 35 U.S.C. 119(a)-(d), the disclosure of which is incorporated herein by reference.

### BACKGROUND OF THE INVENTION

The present invention relates to a method for producing a motor vehicle stabilizer.

The following discussion of related art is provided to assist the reader in understanding the advantages of the invention, and is not to be construed as an admission that this related art is prior art to this invention.

It is known from the state-of-the-art to use motor vehicle stabilizers for improving the driving characteristics and for optimizing the roll behavior of the motor vehicle. These motor vehicle stabilizers connect the respective wheel of one side of the motor vehicle with the wheel arranged on the same axle on the opposite side of the motor vehicle. In most cases a motor vehicle stabilizer is constructed as torsion profile so that a connection is formed on a stabilizer rod from one side of the vehicle to the other side. The connection is usually formed as torsion rod, wherein a deflection of a wheel on one side causes a torsion of the connection or the torsion rod.

Due to the kinematic coupling of the motor vehicle stabilizer with the respective wheel suspension, the torsion rod is bent multiple times at least at its ends, in particular however, also along its extent. Thus, different loads, in particular different tension states, occur in the motor vehicle stabilizer rod at least in sections along the extent.

A motor vehicle stabilizer, which consists of a motor vehicle stabilizer rod is referred to as passive motor vehicle stabilizer. Due to its geometric shape and its strength properties the latter is limited with regard to the stabilizing effect.

In order to extend the field of application, active motor vehicle stabilizers are known from the state of the art in which an actor is connected with a stabilizer half, so that the roll compensation can be influenced at least semi-actively or even actively. With regard to the transverse direction of the motor vehicle, the surface or the material provided by the respective stabilizer-half is thus reduced by the width of the actor.

It would therefore be desirable and advantageous to provide an improved to obviate prior art shortcomings and to forth a production method with which it is possible to produce a stabilizer-half in a load-optimized manner and at the same time cost effectively.

### SUMMARY OF THE INVENTION

According to one aspect of the present invention, a method for producing a motor vehicle stabilizer configured as a hollow tubular component, includes the steps of: providing a steel band made of a high-manganese-content steel alloy having TWIP and/or TRIP properties, forming a tubular profile from the steel strip, longitudinal welding of the tubular profile to form a tube, and bending the tube into the stabilizer rod.

The present invention provides in particular that a high-manganese-content austenitic steel, which has TWIP properties (twinning induced plasticity) or TRIP properties (transformation induced plasticity) is used, having in particular a thickness in the range of more than 2.5 mm. This enables providing a steel strip and to form the steel strip into a tubular profile and to produce an initially endless tube by longitudinal seam welding. By cutting the tube to size it is possible to bend the thus produced tube into the desired stabilizer rod by a bending process and optional further processing it into a motor vehicle stabilizer. In particular a respective end region of a stabilizer rod has to be formed or bent three-dimensionally so that it fits into the installation space while taking the axle kinematic into account. Thus, in the case of a passive, motor vehicle stabilizer which is constructed one-piece and from one material, the stabilizer rod produced from the bent tube is coupled with rubber metal bearings and/or provided for example on the ends with a fixture for connecting the respective axle elements. This may in particular include a flattening of the ends or pressing the ends flat and subsequent perforation for receiving a threaded connection or a bearing. The production of motor vehicle stabilizers are described below. A further processing may also include a coating or varnishing process. For example, the stabilizer rod can be powder coated or varnished. Within the scope of the invention, the stabilizer can also be subjected to a cathodic dip coating process. The varnishing or coating is carried out in particular after finishing all bending and joining operations so that damage to this coating by the bending or joining operation is avoided.

Preferably, a steel alloy is used having the following composition in weight percent:

| | |
|---|---|
| Carbon (C) | max 2% |
| Manganese (Mn) | 10-30% |
| Silicone (Si) | max 6% |
| Aluminum (Al) | max 8% |
| Niobium (Nb) | max 1% |
| Vanadium (V) | max. 1% |
| Titanium (Ti) | max 1% |

Remainder iron and tramp elements.

The term further processing means in particular a processing in the end regions of the thus produced stabilizer rods, wherein the stabilizer rods are for example coupled to an actuator of an active stabilizer or are coupled with a flange, wherein the flange in turn is coupled to the actuator of the active stabilizer. In particular this coupling is performed in a materially bonding manner by welding and/or is form fitting.

Steel strips, in particular in the thickness ranges between 1.5 mm and 10 mm, preferably 2 mm to 8 mm, and particularly preferably between 2.5 and 6 mm are thus initially formed into a tubular profile and a tube is produced by longitudinal seam welding. In particular in its condition upon delivery, the steel strip has a yield strength between 400 and 600 MPa, preferably 450 and 550 MPa and in particular 500 MPa. The cold rolling process results in a strengthening to a yield strength between 1000 and 1400 MPa, in particular between 1100 and 1300 MPa, and preferably of about 1200 MPA. Depending on the dimensions of the tube and the production process, the forming of the tubular profile results in establishing a yield strength on the tube itself of between 600 and 1200 MPa. The longitudinal seam welding changes the yield strength only insignificantly. As a result of the subsequent bending of the tube itself, the yield strength between 600 and 1200 MPa is retained or is increased by the bending process in the bending radii.

Due to the TWIP and/or TRIP properties of the steel, a high strengthening occurs during the forming by twin formation (TWIP effect) or a high strengthening occurs by transformation of metastable, carbon-rich austenite, which is transformed into martensite induced by deformation (TRIP effect).

As a result of the further bending according to the invention of an already thus pre-strengthened tube, a further strengthening then occurs in particular in the bent regions of the bent stabilizer rod. Especially in the bent regions a corresponding strengthening is required in order to achieve a sufficient strength and with this at the same time also durability of the motor vehicle stabilizer, which is exposed to alternating bending stress.

Within the framework of the invention it is thus conceivable that in a particularly preferred embodiment the method is initially carried out such that the strip material in the starting state or in the cold rerolled state is formed into a tubular profile and is then joined to form the corresponding final endless tube by means of high frequency welding or laser welding. In particular the cold rerolling enables setting different strength levels and for different wall thicknesses on the components.

In a further preferred embodiment of the method according to the invention, the component is formed into a tubular profile and subsequently welded to form an endless tube by high frequency welding. The thus produced tube is then stretch reduced over a mandrel, in particular cold stretch reduced, wherein depending on the degree of deformation of the stretch reduction, an intermediate annealing can also occur.

A motor vehicle stabilizer rod produced according to the invention thus does not require cost-intensive heat treatment while still achieving a high strength, wherein the material is initially well formable. This lowers the production costs and, due to the added downstream production steps, the energy requirement in the finishing line. Complex temperature treatment devices and tools with high forming forces are thus not required.

The method further includes longitudinal seam welding of the tubular profile The longitudinal seam welding may be implemented by high frequency welding or laser welding. This results in a homogenous strength distribution over the tube cross section in spite of the thermal joining method, i.e., no significant excessive hardening occurs in the region of the joining seam and/or the heat influence zone so that for example a normalizing treatment subsequent to the thermal joining is not required. This again lowers the production costs.

Due to the absence of complex heat treatment in form of a quenching or normalizing, a further advantage according to the invention is that no edge effects such as a decarbonizing or oxidation occur. In addition no corrosive quenching media are required which in turn increases the durability of a motor vehicle stabilizer produced according to the invention.

Within the scope of the invention it is thus possible to generate an austenitic microstructure in the motor vehicle stabilizer rod, which has a high tenacity and a low rate of crack propagation so that the motor vehicle stabilizer rod is optimally adjusted to the alternating stress loads during its time of use. In particular this is achieved by using a steel that has a carbon content of up to 0.6% and a manganese content between 10 and 35%, in particular between 20 and 30% and other alloy components, remainder iron and smelting related impurities.

Further particularly preferably the steel strip is cold rerolled prior to the forming to a tubular profile. This makes it possible to establish different strengths at least locally due to the rolling degree and/or variation of the wall thickness in such a manner that due to the TWIP and/or TRIP effect an increased strength results in the bent regions, and due to the cold rolling process an increased strength is also established in regions that are not again separately bent or only bent to a minor degree.

According to another advantageous feature of the invention, the tube can also be drawn over a mandrel after the longitudinal seam welding, in particular in the cold drawing method. The mandrel drawing method again results in an increase in strength, wherein this increase in strength is essentially only established after the forming of the steel strip into the tubular profile, which initially ensures a better formability of the tubular profile.

Optionally it is possible within the scope of the invention that the tubular profile is hot formed and/or post treated with heat, in particular the hot forming occurs during the bending of the stabilizer rod. Especially preferably, the heat treatment occurs after the bending of the stabilizer rod. In this context it is then possible that the tool is at least partially cooled, in particular in the case of a hot formed tubular profile.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 schematically illustrates the steps of a production method for a stabilizer rod according to the invention; and

FIG. 2 shows a motor vehicle stabilizer according to the invention.

FIG. 3 is a top view onto an end of a motor vehicle stabilizer;

FIG. 4 is a side view onto the motor vehicle stabilizer shown in FIG. 3.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

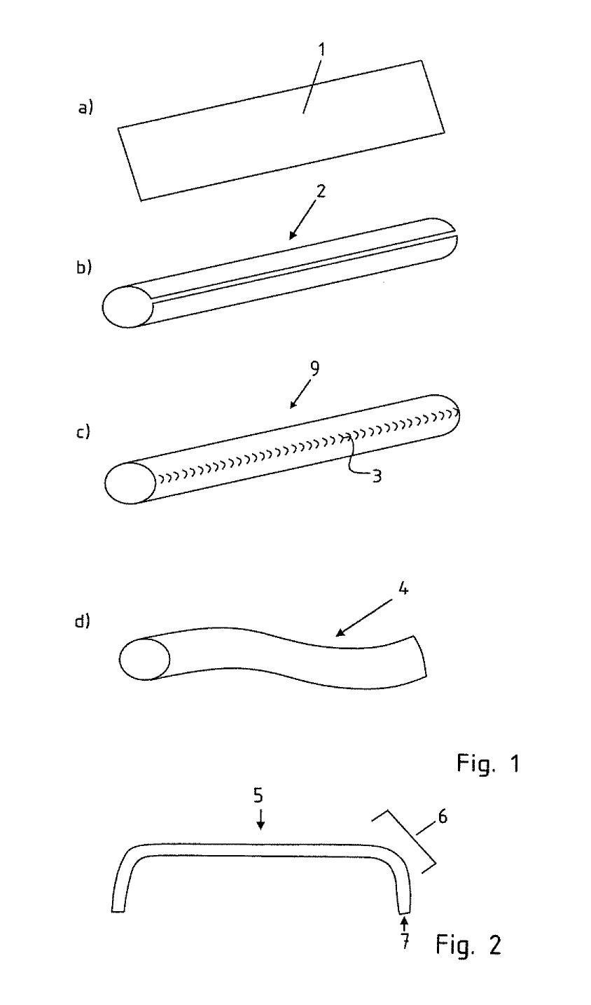

Turning now to the drawing, and in particular to FIG. 1, there is shown the production of a stabilizer rod 4 according to the invention. First, in step a) a cut-to-size steel strip 1 made of a high-manganese-content steel alloy, which has TWIP and/or TRIP properties is provided. In step b) this steel strip 1 is then processed by bending so as to form a tubular profile 2, which in step c) is welded with a longitudinal seam 3 to form a tube 9. Subsequent thereto in step d) the thus produced tube 9 is bent into the stabilizer rod 4.

FIG. 2 shows a corresponding motor vehicle stabilizer 5 which is bent three-dimensionally at its end regions 6 so that it can be coupled at this location for example to a steering knuckle or a transverse control arm.

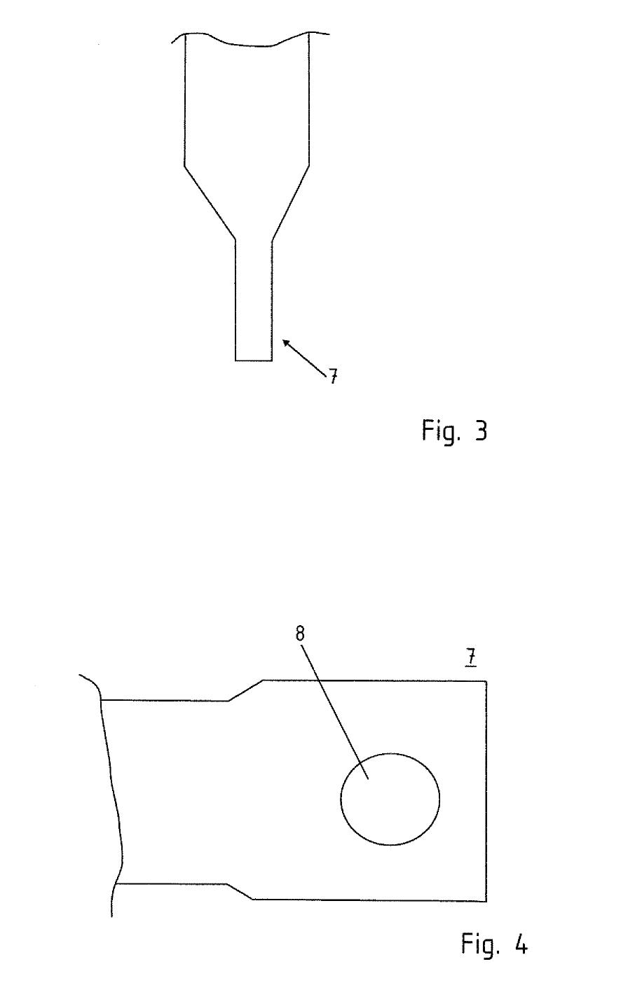

FIG. 3 shows a top view onto an end 7 of the motor vehicle stabilizer 5. The end 7 is compressed so that it can be provided with a hole or a recess 8 according to the side view of the end 7 shown in FIG. 4, for attaching a not further shown threaded connection to an axle element or the like.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a motor vehicle stabilizer configured as a hollow tubular component, comprising the steps of:
providing a steel strip made of a high-manganese-content steel alloy and having TWIP and/or TRIP properties;
forming a tubular profile from the steel strip;
longitudinal seam welding of the tubular profile, thereby forming a tube; and
bending the tube into the stabilizer rod.

2. The method of claim 1, wherein the longitudinal seam welding is implemented by high frequency welding or laser welding.

3. The method of claim 1, further comprising cold rolling the steel strip prior to the forming step.

4. The method of claim 1, wherein during the bending of the tube into the stabilizer rod a strengthening of the steel alloy is generated in bent regions of the stabilizer rod resulting from said bending.

5. The method of claim 1, further comprising after the longitudinal seam welding, stretch reducing the produced tube over a mandrel.

6. The method of claim 5, wherein the produced tube is stretch reduced over the mandrel by cold stretch reducing.

7. The method of claim 6, further comprising annealing the produced tube before or after the cold stretch reducing.

8. The method of claim 1, wherein the tubular profile is formed by hot forming.

9. The method of claim 8, wherein the hot forming is performed in an at least partially cooled tool.

10. The method of claim 1, wherein the motor vehicle stabilizer is constructed as passive motor vehicle stabilizer, further comprising providing a fixture on a respective end of the motor vehicle stabilizer for coupling the passive motor vehicle stabilizer with external components.

11. The method of claim 1, further comprising flattening the respective end and providing the respective end with a recess for connecting a further component.
